(19) United States
(12) Patent Application Publication
(10) Pub. No.: US 2021/0338399 A1
(43) Pub. Date: Nov. 4, 2021

(54) PERIODONTAL POCKET CLEANING DEVICE FOR CLEANING PERIODONTAL POCKETS BY BEING INSERTED INTO PERIODONTAL POCKET FORMED AT BOUNDARY BETWEEN TEETH AND GUMS, AND METHOD FOR MANUFACTURING PERIODONTAL POCKET CLEANING DEVICE

(71) Applicant: Nam Won KANG, Seoul (KR)

(72) Inventor: Nam Won KANG, Seoul (KR)

(21) Appl. No.: 17/271,591

(22) PCT Filed: Aug. 30, 2019
(86) PCT No.: PCT/KR2019/011126

§ 371 Date: Feb. 25, 2021

(30) Foreign Application Priority Data
Aug. 31, 2018 (KR) 10-2018-0103920
Jun. 25, 2019 (KR) 10-2019-0075796

(51) Int. Cl. A61C 17/34; A61C 17/20; A61C 9/00

(52) U.S. Cl. CPC A61C 17/34; A61C 9/0053; A61C 17/20

(57) ABSTRACT

Disclosed is an apparatus for cleaning periodontal pockets configured to be inserted into the periodontal pockets formed at boundaries between teeth and gums so as to clean the periodontal pockets, the apparatus includes a customized frame configured to have a structure which the user puts in a mouth thereof and manufactured to match shapes of teeth and gums of a user, and inserts provided inside the frame and arranged at the boundaries between the teeth and the gums of the user so as to clean the periodontal pockets, and the inserts are formed at different positions for respective teeth of the user so as to correspond to the boundaries of the teeth and the gums, so that the inserts are capable of being inserted into the periodontal pockets despite differences in positions of the periodontal pockets of the respective teeth.

### TECHNICAL FIELD

The present invention relates to an apparatus for cleaning periodontal pockets configured to be inserted into periodontal pockets formed at the boundaries between the teeth and the gums so as to clean the periodontal pockets, and a method for manufacturing the same.

### BACKGROUND ART

Recently, because interest in dental health and oral hygiene has increased, functional toothbrushes having various additional functions are being developed. In additional to the conventional fundamental function of brushing teeth, such functional toothbrushes additionally include a toothpaste-integrated function, an electromotive function, a function of indicating a toothbrushing time, a function of eliminating bad breath, a function of being wearable on a finger, a function of cleaning interdental spaces, etc. In more detail, as conventional functional toothbrushes, various toothbrushes, such as a toothbrush having an interdental toothbrush, dental floss or a toothpick combined with or stored in a toothbrush handle so as to remove foreign substances from interdental spaces, a finger-mounted toothbrush configured such that a dental brush for cleaning teeth is formed on the outer surface of a soft finger cover formed in the shape of a thimble, a toothbrush having a tongue cleaner formed in the shape of a disposable razor or a protrusion at a toothbrush handle and configured such that a user may gently scrape regions deep inside the tongue two or three times so as to clean the coating on the upper surface of the tongue or to mitigate bad breath, a toothbrush for children having a melody generator configured to generate various music or voices, a timer configured to indicate a brushing time or a light emitting device configured to emit various rays of light, which is installed in a toothbrush handle to arouse children's interest so as to enable children to develop a healthy habit and enjoy brushing their teeth, a toothpaste-integrated toothbrush having a space formed in a toothbrush handle so as to be filled with toothpaste or combined with a toothpaste tube so that a toothbrush and toothpaste do not need to be separately carried, etc., have been developed.

However, all of the above-described conventional toothbrushes vary greatly in the brushing effect thereof depending on user's tooth-brushing habits, and are incapable of eliminating the fundamental cause of periodontal diseases even when a user brushes his/her teeth well. Therefore, in order to solve these problems, the inventors of the present invention have completed the present invention through extensive research and trial and error for a long time.

### DISCLOSURE

### Technical Problem

Therefore, the present invention has been made in view of the above problems, and it is an object of the present invention to provide an apparatus for cleaning periodontal pockets which may exhibit an excellent tooth-brushing effect regardless of user's tooth-brushing habits. Particularly, the apparatus for cleaning periodontal pockets according to the present invention provides various configurations which may directly clean periodontal pockets, which are a fundamental cause of periodontal diseases. Periodontal pockets are pocket-type spaces or openings formed between the teeth and the gums, and when the periodontal pockets are formed, the periodontal packets may become filled with infection-causing bacteria and plaque and tartar may easily accumulate thereon and, thus, as time goes on, periodontal diseases worsen and the periodontal pockets gradually become deeper. Periodontal pockets have different depths and different shapes depending on the teeth at which the periodontal pockets are formed and thus it is difficult to clean the periodontal pockets with the conventional toothbrushes, and therefore, the apparatus for cleaning periodontal pockets according to the present invention includes inserts, which are arranged in a frame and are modeled on user's teeth so as to match the positions and depths of periodontal pockets of the user, and are thus capable of cleaning the periodontal pockets which cannot be cleaned by the conventional toothbrushes.

### Technical Solution

In accordance with the present invention, the above and other objects can be accomplished by the provision of an apparatus for cleaning periodontal pockets configured to be inserted into the periodontal pockets formed at boundaries between teeth and gums so as to clean the periodontal pockets, the apparatus including a customized frame configured to have a structure which the user puts in a mouth thereof and manufactured to match shapes of teeth and gums of a user, and inserts provided inside the frame, wherein the inserts are arranged at the boundaries between the teeth and the gums of the user so as to clean the periodontal pockets, and are formed to be tilted at a designated angle relative to the corresponding tooth surface so as to be inserted into the corresponding periodontal pockets formed at the boundaries between the teeth and the gums, and the inserts are formed at different positions for respective teeth of the user so as to correspond to the boundaries of the teeth and the gums, so that the inserts are capable of being inserted into the periodontal pockets despite differences in positions of the periodontal pockets of the respective teeth.

The inserts may be formed to have different lengths so as to match depths of the periodontal pockets of the respective teeth of the user.

The inserts may include blades formed in a blade shape configured to extend in a lateral direction and inserted into the periodontal pockets so as to clean the periodontal pockets.

Each of the blades may include a blade surface configured to extend in the lateral direction so as to form a designated surface, and a tip part formed at a distal end of the blade surface and inserted into the periodontal pockets along the boundaries between the teeth and the gums.

Distal ends of the blades inserted into the periodontal pockets may be formed to have different lengths so as to match depths of the periodontal pockets.

The customized frame may include a stationary part formed regardless of an intraoral structure of the user and configured to receive replaceable parts, and the replaceable parts formed to match the intraoral structure of the user and provided as the inserts.

### Advantageous Effects

The present invention provides an advanced apparatus for cleaning periodontal pockets which may automatically clean the periodontal pockets. The apparatus for cleaning periodontal pockets according to the present invention is manufactured in a shape that a user is capable of placing into his/her mouth, and is configured such that inserts for insertion into the periodontal pockets of the user are arranged in a frame customized to match the structures of the teeth and the gums of the user, and thus, when the user bites the frame with his/her mouth, the inserts may be naturally inserted into the periodontal pockets of the user so as to clean the periodontal pockets.

Further, because vibration is transmitted to the inserts inserted into the periodontal pockets so as to automatically clean the periodontal pockets, the apparatus for cleaning periodontal pockets of the present invention may be conveniently used without requiring the user to directly brush the teeth, and may automatically provide uniform and high cleaning power independent of the user's tooth-brushing habits and skill.

### DESCRIPTION OF DRAWINGS

FIG. 1 is a perspective view illustrating an apparatus for cleaning periodontal pockets according to one embodiment of the present invention.

FIG. 2 is an exemplary cross-sectional view of the apparatus for cleaning periodontal pockets according to one embodiment of the present invention.

FIG. 3 is a view illustrating a method for cleaning periodontal pockets by inserting fine brush hairs according to the present invention into periodontal pockets.

FIG. 4 is a flowchart showing a method for manufacturing an apparatus for cleaning periodontal pockets according to one embodiment of the present invention.

FIG. 5 is a cross-sectional view illustrating inserts of an apparatus for cleaning periodontal pockets according to another embodiment of the present invention.

FIG. 6 is a view illustrating blades of the apparatus for cleaning periodontal pockets according to another embodiment of the present invention.

### BEST MODE

Reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. In the following description of the present invention, a detailed description of known functions and configurations incorporated herein will be omitted when it may make the subject matter of the present invention rather unclear.

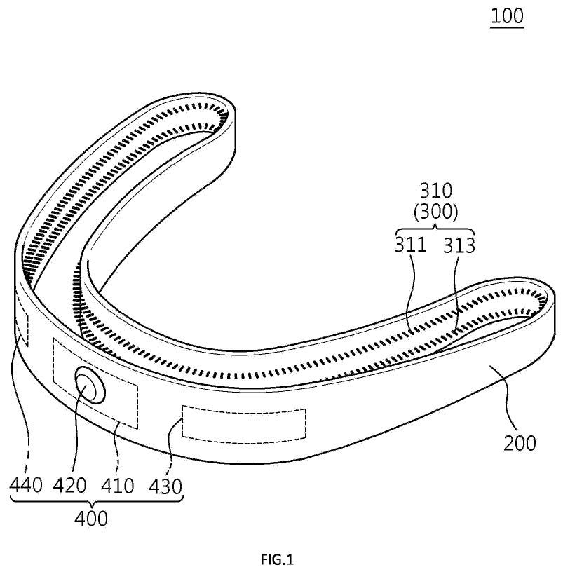

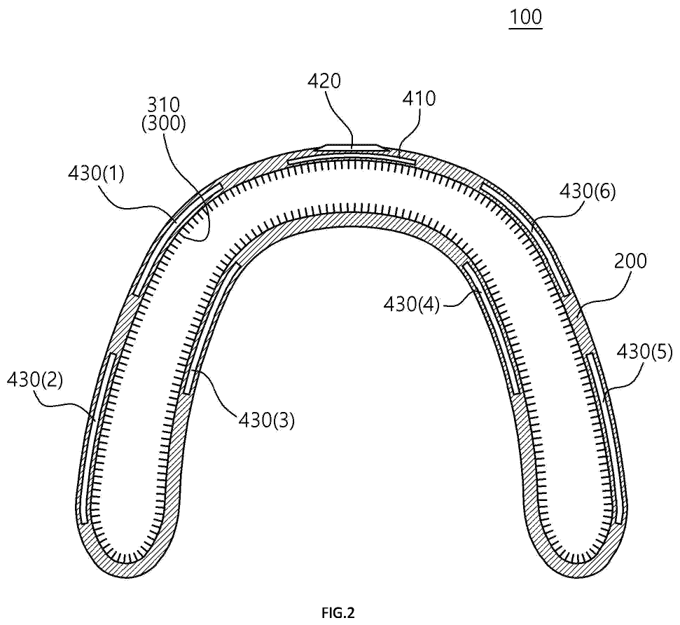

FIG. 1 is a perspective view illustrating an apparatus for cleaning periodontal pockets according to one embodiment of the present invention, and FIG. 2 is an exemplary cross-sectional view of the apparatus for cleaning periodontal pockets according to one embodiment of the present invention.

As shown in FIGS. 1 and 2, an apparatus 100 for cleaning periodontal pockets according to the present invention includes a frame 200, inserts 300, and an electrical device 400.

[Customized Frame]

The positions of periodontal pockets differ depending on each user, and the depths of the periodontal pockets of a user differ for respective teeth of the same user. Therefore, the present invention provides the apparatus 100 for cleaning periodontal pockets including the user-customized frame 200 such that the inserts 300 are accurately inserted into the periodontal pockets of the user so as to precisely clean the periodontal pockets. The frame 200 has a structure which the user bites with his/her mouth, and thus has a shape that accurately matches the user's intraoral structure so that the inserts 300 may be inserted into the periodontal pockets of the user.

In one exemplary embodiment of the present invention, the frame 200 may be manufactured so as to match the shapes of the user's teeth and gums. The frame 200 may be manufactured by being modeled on the sizes, shapes and arrangements of not only the user's upper teeth and gums but also the user's lower teeth and gums. Particularly, the frame 200 precisely matches the boundaries between the user's teeth and gums. For this purpose, a 3D intraoral scanner or the like may be used. However, the disclosure of the present invention is not limited thereto, and an impression of the user's teeth and gums may be directly taken.

[Stationary Part and Replaceable Parts]

Although not shown in the drawings, in another embodiment of the present invention, the frame 200 may be separated into a stationary part and replaceable parts. The stationary part may include the electrical device 400, and may be continuously used regardless of wear of the inserts 300. The stationary part may be mass-produced so as to have a designated shape regardless of the user's intraoral structure.

The replaceable parts have a shape that precisely matches the user's intraoral structure, and may include the inserts 300. When the inserts 300 are worn out, only the replaceable parts, i.e., the inserts 300, may be separated from the stationary part and replaced with new ones without replacing the stationary part including the electrical device 400, and thereby, maintenance and management costs may be reduced. Further, a plurality of user may use the same apparatus 100 for cleaning periodontal pockets merely by replacing the existing replaceable parts with replaceable parts that match their own intraoral structures, while using the same stationary part.

[Inserts]

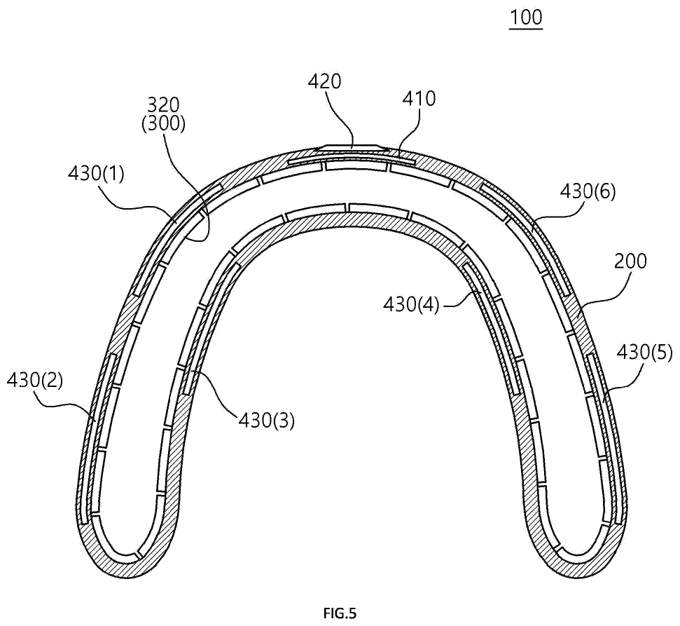

The inserts 300 are provided inside the frame 200 and include various types of components which are inserted into the periodontal pockets. The inserts 300 are inserted into the periodontal pockets so as to clean the periodontal pockets. The inserts 300 may include fine brush hairs 310 which are inserted into the periodontal pockets so as to clean the periodontal pockets. However, the inserts 300 according to the present invention are not limited thereto, and may include blades, as shown in FIG. 5. The blades will be described below with reference to FIG. 5.

Further, in one exemplary embodiment of the present invention, the inserts 300 may further include toothbrushes or gums brushes (not shown) configured to clean tooth surfaces or to massage the gums.

The inserts 300 may be formed in a manner of being implanted into the frame 200 or into the replaceable parts which constitute the frame 200. However, the inserts 300 may be formed integrally with the frame 200 or the replaceable parts when the frame 200 or the replaceable parts are formed.

[Arrangement of Fine Brush Hairs]

The fine brush hairs 310 include upper fine brush hairs 311 configured to clean periodontal pockets formed between the upper teeth and the gums, and lower fine brush hairs 313 configured to clean periodontal pockets formed between the lower teeth and the gums. The fine brush hairs 310 are arranged at the boundaries between the teeth and the gums (i.e., at the positions of the periodontal pockets), and are inserted into the periodontal pockets so as to clean the periodontal pockets. The fine brush hairs 310 are formed at positions corresponding to the boundaries between the teeth and the gums, and may consequently be arranged at different positions for respective teeth. Because the fine brush hairs 310 are arranged at different positions for respective teeth, the fine brush hairs 310 may be more precisely inserted into the corresponding periodontal pockets.

[Angle of Fine Brush Hairs]

The fine brush hairs 310 may be formed to be tilted at a designated angle relative to the corresponding tooth surface so as to be inserted into the corresponding periodontal pocket. The angle of the fine brush hairs 310 may vary depending on the tooth. For example, the angle of the fine brush hairs 310 arranged at the molars and the angle of the fine brush hairs 310 arranged at the canines may be different. For example, the angle between the surface of the canine and the fine brush hairs 310 may be 30 degrees, and the angle between the surface of the molar and the fine brush hairs 310 may be 45 degrees. In one exemplary embodiment, the tilt angles of the fine brush hairs 310 may be 30 to 45 degrees, without being limited thereto.

[Length of Fine Brush Hairs]

The fine brush hairs 310 may be formed to have different lengths so as to match the depths of the periodontal pockets depending on the user's respective teeth. The depths of the periodontal pockets of a user differ for the respective teeth of the same user based on the state of the teeth and the gums of the user or the user's condition or health state. Therefore, in order to more precisely clean the periodontal pockets, the fine brush hairs 310 may be formed to have different lengths so as to match the depths of the periodontal pockets depending on the user's respective teeth. For this purpose, in the present invention, the depths of the periodontal pockets may be periodically remeasured (for example, at a point in time at which the fine brush hairs 310 are worn out and thus need to be replaced), and the lengths of the fine brush hairs 310 may be set differently so as to match the remeasured depths of the periodontal pockets. Further, changes in the depths of the periodontal pockets, which are measured periodically or aperiodically, may be stored in a database and monitored, and thus, advice on the user's oral health may be provided.

[Electrical Device]

The electrical device 400 may include a controller 410, a switch 420, insert vibrators 430, and a battery 440. The controller 410 controls the apparatus 100 for cleaning periodontal pockets. The controller 410 may receive an ON/OFF input signal from the switch 420 and control the operating time, the intensity, etc. of the insert vibrators 430. The switch 420 may receive an ON/OFF input signal from a user. The insert vibrators 430 may transmit vibration to the inserts 300 so that the inserts 300 automatically clean the periodontal pockets. The insert vibrators 430 may be installed in a manner of being adhered to the inner surface or the outer surface of the frame 200. Here, a plurality of insert vibrators 430 may be provided. The plural insert vibrators 430 may be spaced apart from one another by a designated interval in order to effectively transmit vibration to the inserts 300. The insert vibrators 430 may be ultrasonic vibrators which use cavitation generated by ultrasonic waves. Cavitation is a phenomenon in which, when ultrasonic energy is propagated in a solution, micro-bubbles are generated due to the ultrasonic pressure and collapse. When power of a high level is applied to the ultrasonic vibrators so as to generate high-frequency ultrasonic waves, the size of the micro-bubbles is increased, and when power of a low level is applied to the ultrasonic vibrators so as to generate low-frequency ultrasonic waves, the size of the micro-bubbles is decreased. The controller 410 may vary the frequency within one cleaning cycle, thereby being capable of increasing the cleaning power. However, the insert vibrators 430 of the present invention are not limited to ultrasonic vibrators. The battery 440 may store energy and supply the stored energy to the electrical device 400.

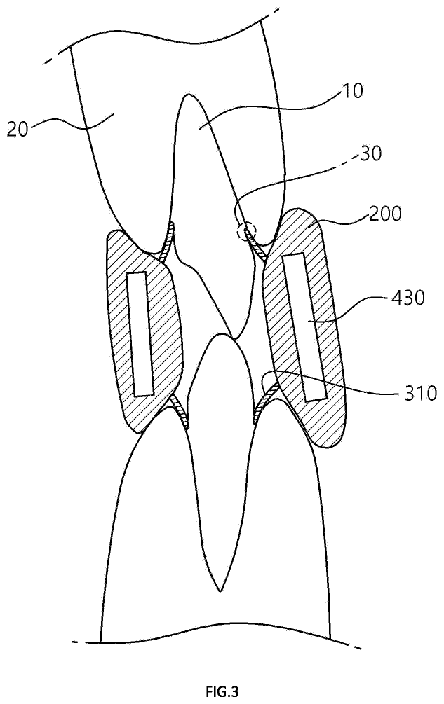

FIG. 3 is a view illustrating a method for cleaning periodontal pockets by inserting the fine brush hairs according to the present invention into the periodontal pockets.

As shown in FIG. 3, when a user places the apparatus for cleaning periodontal pockets in his/her mouth and bites the frame 200 with his/her mouth, the fine brush hairs 310, fixed at positions corresponding to periodontal pockets 30 of the user, are inserted into the periodontal pockets 30 formed between teeth 10 and gums 20. Concretely, because the frame 200 is manufactured to be customized so as to match the structures of the user's teeth 10 and the gums 20, when the user bites the frame 20 with his/her mouth, the fine brush hairs 310 may always be disposed at designated positions. Because the fine brush hairs 310 are formed at different positions depending on the respective teeth 10 (i.e., the positions of the periodontal pockets 30) and have different lengths depending on the respective teeth 10, the fine brush hairs 310 may be more precisely inserted into the corresponding periodontal pockets 30. When the insert vibrators 430 transmit vibration to the fine brush hairs 310, the fine brush hairs 310 automatically clean the periodontal pockets 30 so as to remove foreign substances from the periodontal pockets 30.

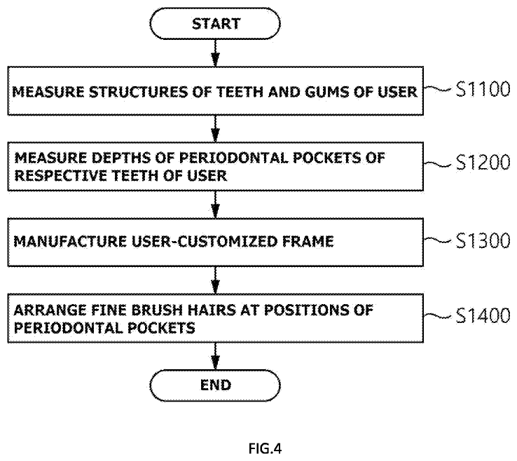

FIG. 4 is a flowchart showing a method for manufacturing an apparatus for cleaning periodontal pockets according to one embodiment of the present invention.

As shown in FIG. 4, the structures of the teeth and the gums of a user are measured (S1100). Here, the structures of the teeth and the gums of the user may be scanned using a 3D intraoral scanner.

Thereafter, the depths of periodontal pockets formed at the respective teeth of the user are measured (S1200). The depths of the respective periodontal pockets of the user differ for the respective teeth of the user based on the state of the teeth and the gums of the user or the user's condition or health state. Therefore, the depths of the periodontal pockets of the respective teeth may be measured, and a periodontal pocket depth measurement tool or apparatus may be used to measure the depths of the periodontal pockets. Further, the depths of the periodontal pockets of the respective teeth may be measured periodically or aperiodically, and may be cumulatively stored in a database.

Thereafter, a frame is manufactured to be customized so as to match the structures of the user's teeth and gums so that the user may place the frame in his/her mouth and bite the frame with his/her mouth (S1300). As described above, the frame may be separated into a stationary part and replaceable parts. The stationary part may include an electrical device, and may be continuously used regardless of wear of inserts. The replaceable parts have a shape that precisely matches the user's intraoral structure, and may include the inserts. In an embodiment in which the stationary part and the replaceable parts are separable from each other, the stationary part may be produced once so as to be continuously used and only the replaceable parts may be replaced with newly produced replaceable parts based on the wear cycle of fine brush hairs.

The fine brush hairs configured to match the depths of the periodontal pockets of the respective teeth are arranged in the frame so as to correspond to the positions of the periodontal pockets formed at the boundaries between the teeth and the gums. When new replaceable parts are produced, the depths of the periodontal pockets may be remeasured, and the lengths of the fine brush hairs of the replaceable parts may be adjusted depending on the remeasured depths of the periodontal pockets.

### OTHER EMBODIMENTS

An apparatus for cleaning periodontal pockets according to another embodiment of the present invention may further include a liquid injection hole. Water or liquid toothpaste may be supplied through the liquid injection hole. In one exemplary embodiment, the liquid injection hole may be formed at a position adjacent to the inserts or the lower ends of the inserts so as to supply water or the liquid toothpaste to the fine brush hairs of the inserts. When the liquid injection hole is formed at the position adjacent to the inserts or the lower ends of the inserts, the water or the liquid toothpaste discharged from the liquid injection hole may easily flow along the inserts so as to be supplied to the teeth or the periodontal pockets.

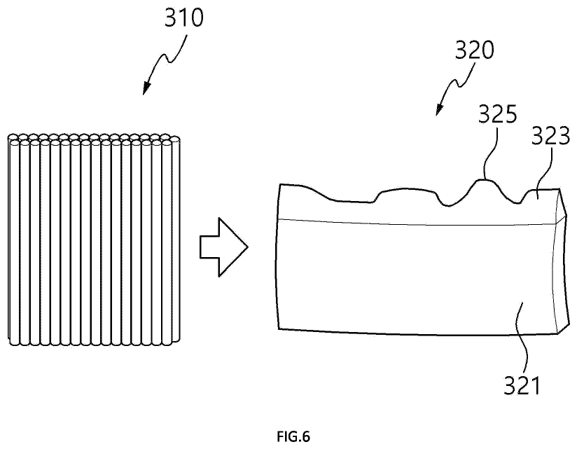

FIG. 5 is a cross-sectional view illustrating inserts of an apparatus for cleaning periodontal pockets according to another embodiment of the present invention, and FIG. 6 is a view illustrating blades of the apparatus for cleaning periodontal pockets according to another embodiment of the present invention. Because the concept of the blades is subordinate to that of the inserts, the blades have common characteristics with the fine brush hairs except for the parts of the blades having a shape differing from the fine brush hairs. Therefore, a detailed description of parts of the blades that are substantially the same as those of the fine brush hairs will be omitted, and only the parts of the blades that differ from the fine brush hairs will be described below.

As shown in FIGS. 5 and 6, the inserts 300 may include blades 320.

The blades 320 are formed in a plate shape or a blade shape that extends in a lateral direction to form a designated surface, and are inserted into periodontal pockets in a direction perpendicular to the lateral direction so as to clean the periodontal pockets.

The blades 320 may be more easily inserted into the periodontal pockets compared to the fine brush hairs 310. Because each of the blades 320 includes a blade surface 321, the blades 320 may maintain higher stiffness than the fine brush hairs 310, thus being capable of being more easily inserted into the periodontal pockets compared to the fine brush hairs 310.

In one exemplary embodiment, each of the blades 320 may include the blade surface 321 and a tip part 323. The blade surface 321 extends in the lateral direction to form a designated surface. The tip part 323 is formed at the distal end of the blade surface 321, and is inserted into the periodontal pockets along the boundaries between the teeth and the gums. The tip part 323 has a structure having a thickness that decreases in a direction towards the distal end thereof. The tip part 323 having the above structure may be more easily inserted into the periodontal pockets along the boundaries between the teeth and the gums.

Further, in another embodiment, the length 325 of the distal end of the blade 320 may vary so as to match the depths of the periodontal pockets. There is a difference in the depths of periodontal pockets between individuals, and the depths of the respective periodontal pockets of a user differ for the respective teeth of the same user based on the state of the teeth and the gums of the user. Therefore, by varying the lengths of the distal ends of the blades 320 so as to match the depths of the periodontal pockets, the periodontal pockets may more precisely cleaned.

1. A method for manufacturing an apparatus for cleaning periodontal pockets configured to be inserted into the periodontal pockets formed at boundaries between teeth and gums so as to clean the periodontal pockets, the method comprising:
three-dimensionally scanning shapes of teeth and gums of a user;
measuring depths of periodontal pockets of respective teeth of the user;
preparing a customized frame manufactured to match the teeth and the gums of the user so that the user is capable of biting the frame with a mouth thereof to put the frame in the mouth thereof; and
arranging fine brush hairs, configured to correspond to positions of the periodontal pockets formed at the boundaries between the teeth and the gums of the user and to match the depths of the periodontal pockets of the respective teeth, in the frame.

2. An apparatus for cleaning periodontal pockets configured to be inserted into the periodontal pockets formed at boundaries between teeth and gums so as to clean the periodontal pockets, the apparatus comprising:
a customized frame configured to have a structure which the user puts in a mouth thereof and manufactured to match shapes of teeth and gums of a user; and
inserts provided inside the frame and arranged at the boundaries between the teeth and the gums of the user so as to clean the periodontal pockets,
wherein the inserts are formed at different positions for respective teeth of the user so as to correspond to the boundaries of the teeth and the gums, so that the inserts are capable of being inserted into the periodontal pockets despite differences in positions of the periodontal pockets of the respective teeth.

3. The apparatus according to claim 2, wherein the inserts are formed to have different lengths so as to match depths of the periodontal pockets of the respective teeth of the user.

4. The apparatus according to claim 2, wherein the inserts comprise blades formed in a blade shape configured to extend in a lateral direction and inserted into the periodontal pockets so as to clean the periodontal pockets.

5. The apparatus according to claim 4, wherein each of the blades comprises:
a blade surface configured to extend in the lateral direction so as to form a designated surface; and
a tip part formed at a distal end of the blade surface and inserted into the periodontal pockets along the boundaries between the teeth and the gums.

6. The apparatus according to claim 4, wherein distal ends of the blades inserted into the periodontal pockets are formed to have different lengths so as to match depths of the periodontal pockets.

7. The apparatus according to claim 2, wherein the customized frame comprises:
a stationary part formed regardless of an intraoral structure of the user and configured to receive replaceable parts; and
the replaceable parts formed to match the intraoral structure of the user, and provided as the inserts.

8. The apparatus according to claim 2, wherein the customized frame is formed by being modeled on the boundaries between the teeth and the gums of the user using a 3D intraoral scanner or by taking an impression of the teeth and the gums of the user, and the inserts are arranged to match the boundaries between the teeth and the gums, which differ for the respective teeth, so that the inserts are capable of being inserted into the periodontal pockets despite the differences in the positions of the periodontal pockets of the respective teeth.
